(19) United States
(12) Patent Application Publication
(10) Pub. No.: US 2017/0291755 A1
(43) Pub. Date: Oct. 12, 2017

(54) TICKET DISPENSER WITH INSERT

(71) Applicant: Owner Revolution Inc., Adair, IA (US)

(72) Inventor: Bruce WATSON, Atlantic, IA (US)

(73) Assignee: Owner Revolution Inc., Adair, IA (US)

(21) Appl. No.: 15/096,487

(22) Filed: Apr. 12, 2016

(51) Int. Cl. B65D 83/08; G07F 17/32; B65D 83/12

(52) U.S. Cl. CPC B65D 83/0805; B65D 83/12; G07F 17/329

(57) ABSTRACT

Example embodiments disclose novel ticket dispenser having an insert configured to support a plurality of tickets. In at least one example embodiment, the ticket dispenser may be comprised of a body, a door pivotally connected to the body, and an insert in the body. In at least on example embodiment, the body includes a pair of spaced apart side walls, a top wall, a bottom wall, and a back wall. In at least one example embodiment the insert includes a floor with a plurality of parallel grooves having lengths extending in a direction perpendicular to the pair of spaced apart side walls, a back portion facing the back wall, and a top portion facing the top wall.

### BACKGROUND

### 1. Field

Example embodiments relate to a ticket dispenser with an insert.

### 2. Description of the Prior Art

Lottery tickets are often manufactured as perforated ribbons having perforations to separate individual tickets. The perforations allow the tickets to be easily separated from one another.

Lottery tickets are often housed in dispensing units. The dispensing units typically include a body which resembles a box having an open end into which the lottery tickets may be placed. The lottery ticket dispensing units also generally include a pivotable housing door to cover the open end of the body to protect to lottery tickets. The housing door generally includes an elongated dispensing aperture through which the ribbon of tickets may pass and be dispensed. In some lottery ticket dispensers the housing door includes a pair of rollers over which tickets pass as they are withdrawn from within the housing.

A typical problem associated with ticket dispensing units is that ribbon like cards are prone to falling backwards into the body so that a card protruding from the elongated dispensing aperture is often pulled back into the body. This requires a user to open in the door and restack the cards. In addition, ticket dispensing units are fabricated with substantially transparent materials. This is helpful to both vendors of tickets and customers since the transparent materials allow the vendors and customers to view the contents of the ticket dispenser without having to open the ticket dispenser, however, when the tickets fall in the body, as described above, the tickets may be difficult to view.

### SUMMARY

Example embodiments disclose a novel ticket dispenser having an insert configured to support and stabilize a plurality of tickets. In at least one example embodiment, the ticket dispenser may be comprised of a body, a door pivotally connected to the body, and an insert in the body. In at least one example embodiment, the body includes a pair of spaced apart side walls, a top wall, a bottom wall, and a back wall. In at least one example embodiment the insert includes a floor with a plurality of parallel grooves having lengths extending in a direction perpendicular to the pair of spaced apart side walls, a back portion facing the back wall, and a top portion facing the top wall.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a ticket dispenser module in accordance with example embodiments;

FIG. 2 is a perspective view of an insert in accordance with example embodiments;

FIG. 3 is a side view of the insert in accordance with example embodiments;

FIG. 4 is a view of a body of the ticket dispenser module with the insert inserted therein in accordance with example embodiments;

FIG. 5 is a cross section view of the ticket dispenser module with the insert and a ribbon of tickets therein in accordance with example embodiments;

FIG. 6 is a close-up view of the ticket dispenser module with the insert and the ribbon of tickets therein in accordance with example embodiments;

FIG. 7 is a back view of the ticket dispenser module with the insert and the ribbon of tickets therein in accordance with example embodiments;

FIG. 8 is a view of another insert in accordance with example embodiments;

FIG. 9 is a view of another insert in accordance with example embodiments;

FIG. 10 is a view of the body of the ticket dispenser module in accordance with example embodiments; and

FIG. 11 is a view of a door of the ticket dispenser module in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a ticket dispenser module with an insert.

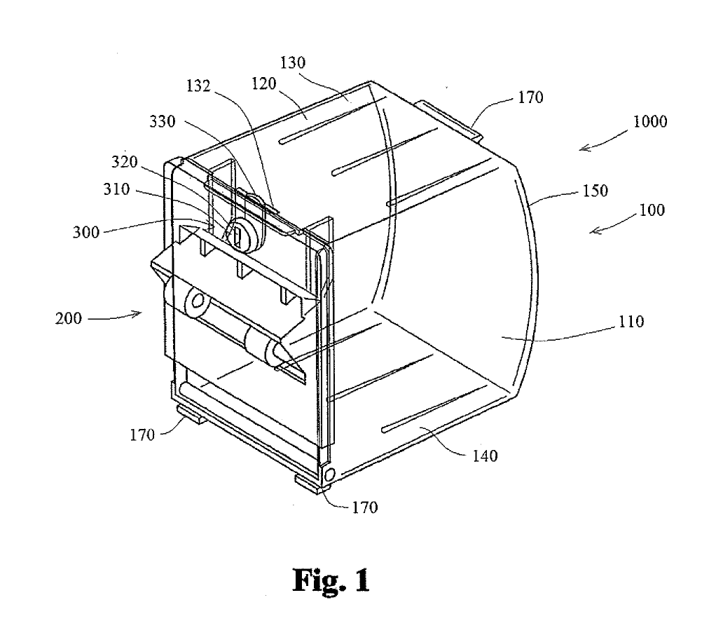

FIG. 1 is a view of a ticket dispenser module 1000 in accordance with an example of the invention. The ticket dispenser module 1000, in this nonlimiting example, may be suitable for dispensing tickets, for example, a ribbon of tickets such as, but not limited to, lottery tickets and/or bingo tickets. In the nonlimiting example of FIG. 1, the ticket dispenser module 1000 comprises a housing body 100, a housing door 200 rotatably attached to the housing body 100, and a lock assembly 300.

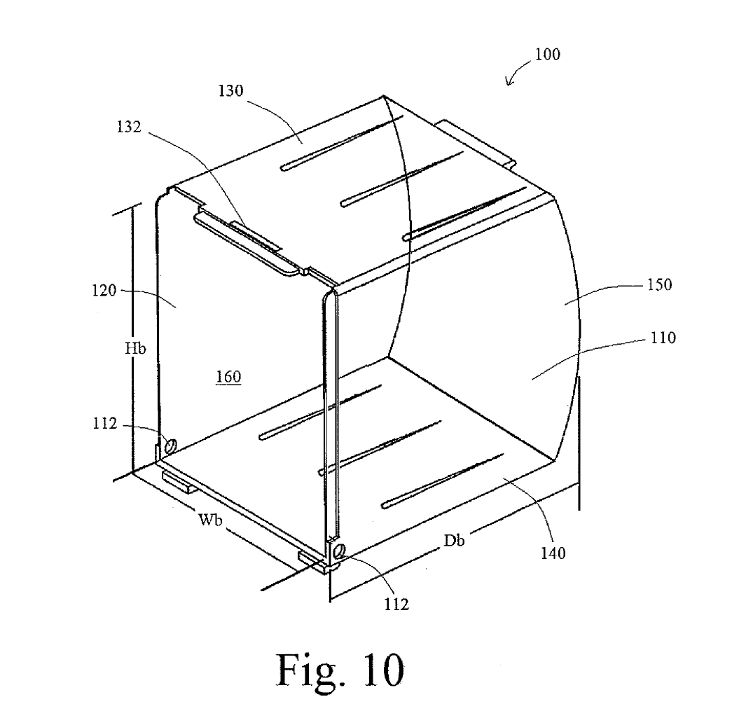

In example embodiments the housing body 100 may resemble a hollow box with an open end. For example, in FIG. 1, the housing body 100 comprises spaced apart side walls 110 and 120, top wall 130, bottom wall 140, and back wall 150. These walls form a box like structure with an open end 160 (see FIG. 10). The housing body 100 may also have interconnection elements 170 configured to interconnect the housing body 100 to another ticket dispenser module 1000. The side walls 110 and 120 and the top and bottom walls 130 and 140 are illustrated as substantially flat parallel walls while the back wall 150 is illustrated as a curved wall. These features, however, are not critical to the invention as the back wall 150 may be flat rather than curved and the side walls 110 and 120 and the top and bottom walls 130 and 140 may be curved rather than flat.

In example embodiments the housing body 100 may be made from a single material, for example, through a molding process, and the material may be a transparent or a semitransparent material, for example, a transparent plastic. On the other hand, each of the walls 110, 120, 130, 140, and 150 may be separately formed and then assembled to form the body 100. For example, each of the walls may be separately manufactured and then connected to one another via an adhesive. As such, the different walls may be made from different materials. For example, the side walls 110 and 120 and the top and bottom walls 130 and 140 may be made from a non-transparent material while the back wall 150 may be made from a transparent material or a semitransparent material.

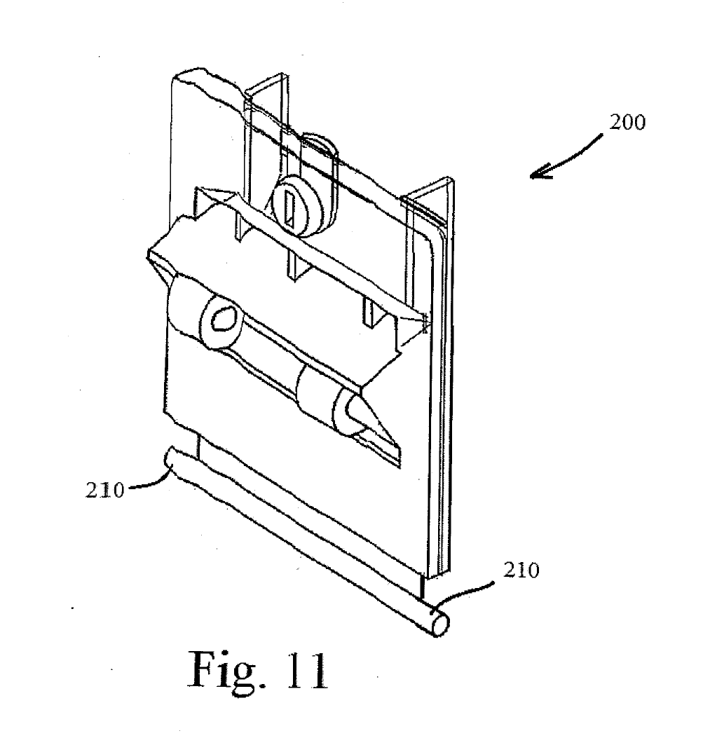

Near the open end 160 and the bottom wall 140, sides walls 110 and 120 of the housing body 110, are provided with pivotal door engagement elements 112 (for example, holes, see FIG. 10). The housing door 200, for its part, has pivotal body engagement elements 210 (for example, shafts, see FIG. 11) configured to engage with the pivotal door engagement elements 112 of the housing body 100. Such an arrangement allows the housing door 200 to pivotally attach to the body 100 via the pivotal door engagement elements 112 and the pivotal body engagement elements 210. This particular arrangement, however, is not meant to limit the invention. For example, the pivotal door engagement elements may resemble shafts and the pivotal body engagement elements may resemble tabs with holes into which the pivotal door engagement elements may insert. In addition, rather than using the above means to connect the housing door 200 to the housing body 100 hinges may be used to connect the housing door 200 to the housing body 100.

The lock assembly 300 may be attached to the housing door 200 and may rigidly move with the housing door 200. For example, rotating the housing door 200 would also rotate the lock assembly 300. The lock assembly 300 may comprise a central lock mechanism 310 with a key insertion slot 320, and a multi-way locking arm 330. The multi-way locking arm 330 may project from the central axis of rotation of the lock mechanism 310. The illustrated central lock mechanism 310 may be configured for operation with a toothed key. Alternatively, the central lock mechanism 310 may be configured for operation with a non-toothed key, such as a polygonal key (e.g. a square section key or an Allen® key). In a further alternative, in a case where a removable key is not required, then the lock assembly 300 may be provided with a handle for operation of the multi-way locking arm 330. In the nonlimiting example of FIG. 1, the multi-way locking arm 330 may be rotated into a locking arm receiving slot 132 which may be provided in the top wall 130 of the housing body 100 in order to lock the ticket dispenser module 1000. FIG. 1, for example, shows the ticket dispenser module 1000 in a locked configuration. The ticket dispenser module 1000 may be unlocked by inserting a key into the key insertion slot 320 and rotating the key to rotate the multi-way locking arm 330 out of the multi-way locking arm receiving slot 132.

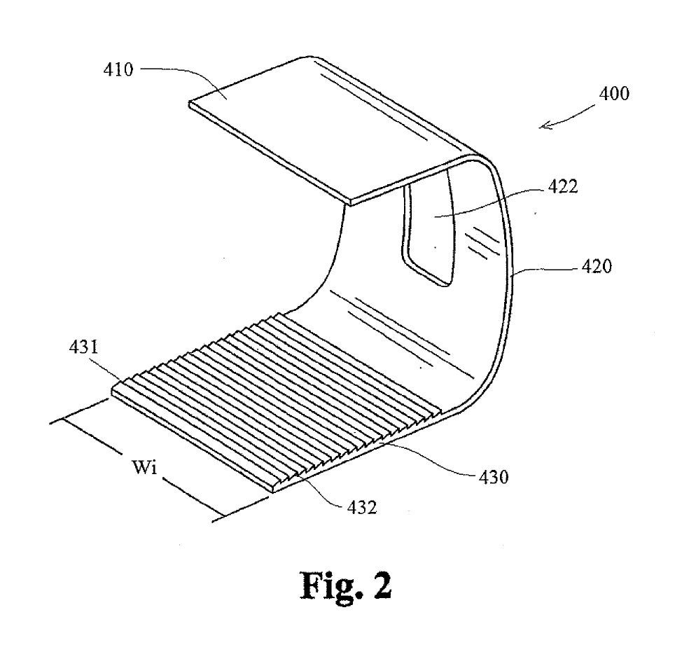

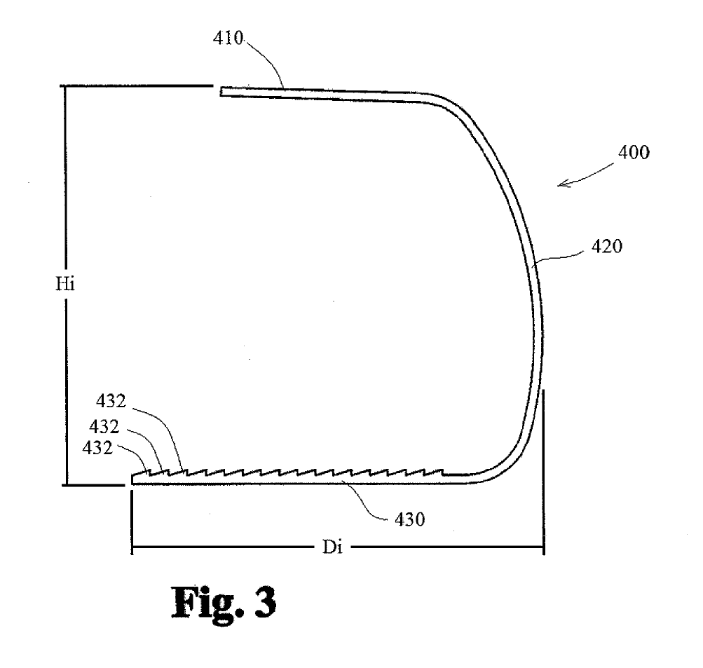

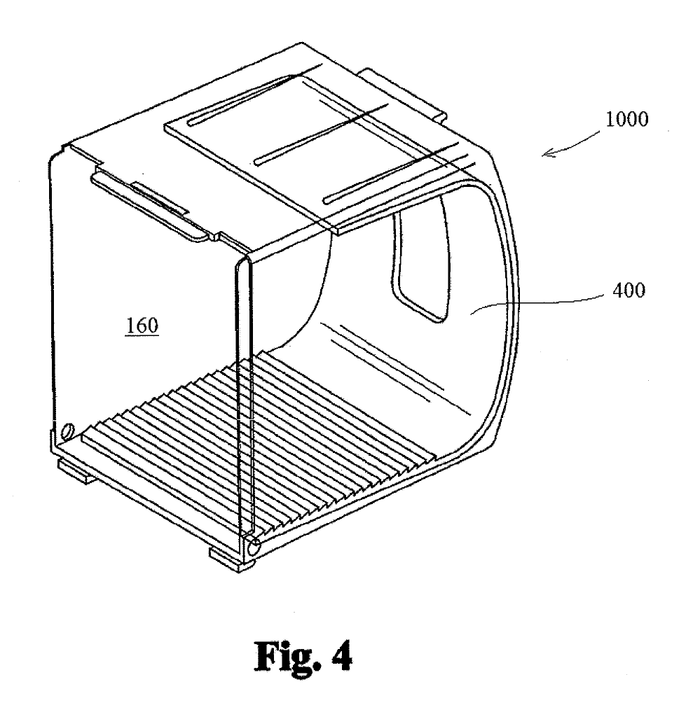

FIG. 2 is a perspective view of an insert 400 in accordance with example embodiments. FIG. 3 is a side view of the insert 400. As shown in FIGS. 2 and 3 the insert 400 may include a top portion 410, a back portion 420, and a floor 430. In at least one nonlimiting example embodiment, the floor 430 may have a plurality of grooves 431 which may form a plurality of teeth 432. The teeth 432, when viewed from the side, may appear to have a triangular or saw tooth profile. A width Wi of the insert 400 may be about the same as, or smaller than the width Wb of the body 100, a height Hi of the insert 400 may be about the same as or smaller than the height Hb of the body 100, and a depth Di of the insert 400 may be about the same size or smaller than a depth Db of the body 100 to allow the insert 400 to insert into the body 100 as shown in FIG. 4 (see FIG. 10 for dimension of the body 100).

In example embodiments, the insert 400 may be inserted into the housing body 100 so that the back portion 420 faces the back wall 150 and the top portion 410 faces the top wall 130. In addition, the grooves 431 may extend in a direction which is perpendicular to the side walls 110 and 120. The height Hi of the insert 400 may allow for a first gap between a bottom surface of the top wall 130 and a top surface of the top portion 410 of the insert 400. Also, a second gap may also reside between a back surface of the back portion 420 and a surface of the back wall 150. This latter gap, in some embodiments, may disappear at some points to create a pinch point which may be used to sandwich and secure an item, for example, a lottery ticket, between the back portion 420 and the back wall 150. The pinch points, however, are not necessary and may not be present between the back portion 420 of the insert 400 and the back wall 150 of the housing body 100.

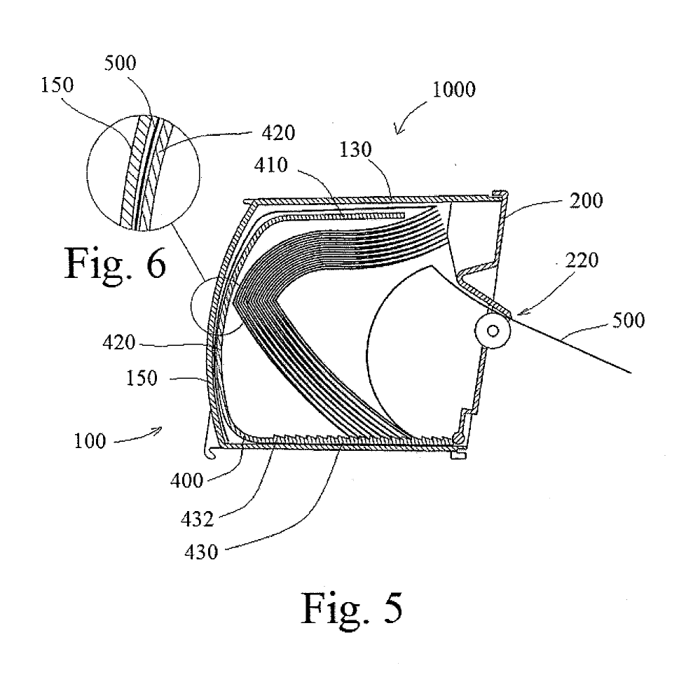

FIG. 5 is a view of the insert 400 inserted into the body 100 with the door 200 locked. FIG. 5 also shows a plurality of ribbon tickets 500, for example, lottery or bingo tickets, enclosed by the body 100. As shown in FIG. 5, bottom edges of the tickets 500 may contact the floor 430 of the insert 400. The teeth 432 on the floor 430 may provide bearing surface which may support, orientate, and stabilize the ribbon tickets 500. One end of the plurality of ribbon tickets 500 may extend backwards and along the top portion 410 of the insert 400 between the top portion 410 and the top wall 130 of the housing body 100 and between the back portion 420 of the insert 400 and the back wall 150 of the body 100. The other end of the plurality of ribbon tickets 500 may be fed through a longitudinal opening 220 of the housing door 200.

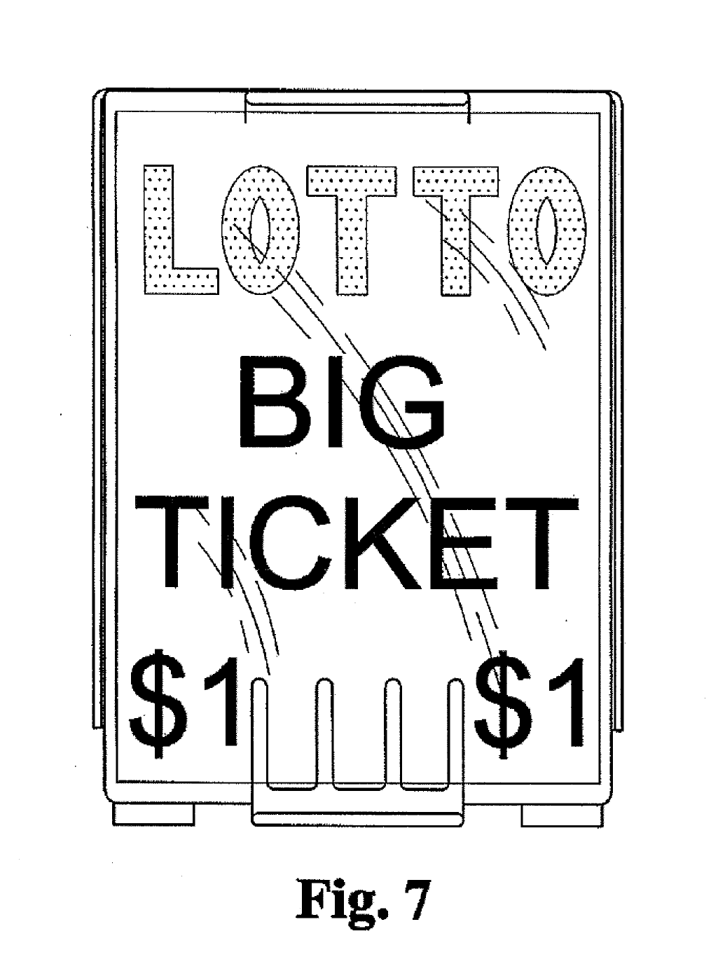

The ticket dispenser module 1000 with the insert 400 provides several advantages over the conventional art. FIG. 7, for example, shows a back view of the ticket dispenser module 1000 with the insert 400 and ribbon tickets 500 inside. As shown in FIG. 7, at least one of the tickets may be vertically supported by the insert 400 between the back portion 420 and the back wall 150 so that an observer could easily view what types of tickets are in the ticket dispenser module 1000 when the back wall 150 includes a transparent or semitransparent material. Furthermore, without the insert 400, the tickets may tend to fall or become inclined making it difficult for an observer to determine what cards are in the ticket dispenser module 1000. Furthermore, the toothed floor 430 allows for cards to stack in an orderly fashion inside the ticket dispenser module 1000 and stabilizes the stacked cards such that the tendency of the cards to fall down is reduced.

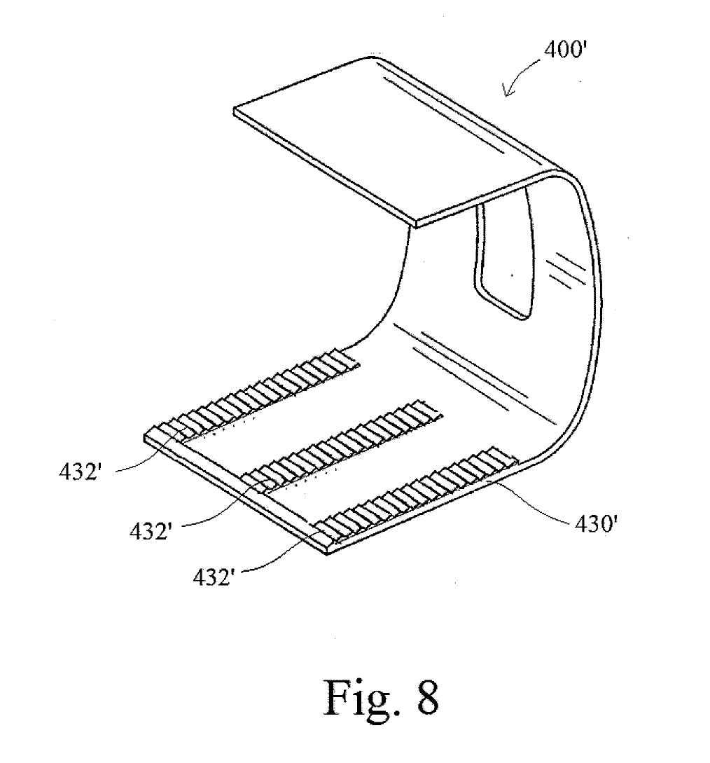

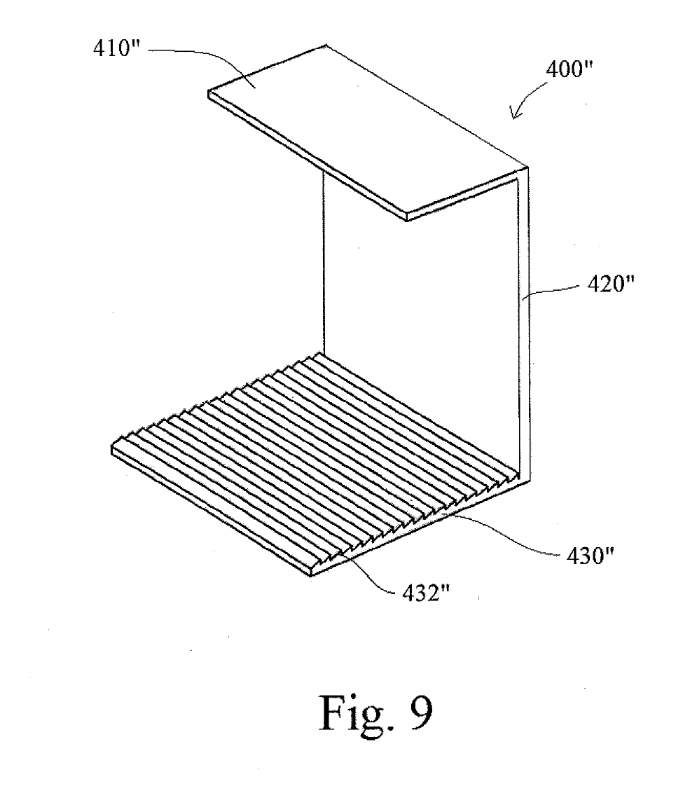

It is understood that the invention is not limited to that shown in FIGS. 1-7. For example, FIG. 8 illustrates another example of an insert 400′ usable with example embodiments. The insert 400′ may be substantially identical to the insert 400 except that rather than providing teeth which extend along a width of the floor 430, the floor 430′ is provided with a plurality of columns of teeth 432′. FIG. 9, for example, illustrates another example of an insert 400″. The insert 400″ may be substantially identical to the insert 400 except that the back wall 420″ of the insert 400″ is substantially flat rather than curved.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

1. A ticket dispenser comprising:
a body comprised of a pair of spaced apart side walls, a top wall, a bottom wall, and a back wall;
a door pivotally connected to the body; and
an insert in the body, the insert including a floor with a plurality of parallel grooves forming a plurality of teeth having lengths extending in a direction perpendicular to the pair of spaced apart side walls, a back portion facing the back wall, and a top portion facing the top wall, wherein the plurality of teeth are configured to support a plurality of tickets by the tickets' edges.

2. (canceled)

3. The ticket dispenser of claim 1, wherein the teeth have a triangular shape.

4. The ticket dispenser of claim 1, wherein the back wall is a curved wall and the back portion is curved.

5. The ticket dispenser of claim 4, wherein the top portion includes a substantially flat portion and the top wall is a substantially flat wall.

6. The ticket dispenser of claim 5, wherein a first gap is between the top portion and the top wall and a second gap is between the back portion and the back wall.

7. The ticket dispenser of claim 1, wherein the back wall and the back portion are configured to form at least one pinch point.

8. The ticket dispenser of claim 1, further comprising:
a ribbon of tickets, wherein at least one of the tickets is arranged between the back portion and the back wall.

9. The ticket dispenser of claim 8, wherein some of the tickets have bottoms contacting the grooves in the floor.

10. The ticket dispenser of claim 9, wherein at least some of the tickets are between the top portion and the top wall.

11. The ticket dispenser of claim 1, wherein the back wall comprises a transparent material.
